(19) United States
(12) Patent Application Publication
(10) Pub. No.: US 2025/0022292 A1
(43) Pub. Date: Jan. 16, 2025

(54) DRIVER MONITORING DEVICE, DRIVER MONITORING METHOD, AND NON-TRANSITORY RECORDING MEDIUM

(71) Applicants: TOYOTA JIDOSHA KABUSHIKI KAISHA, Toyota-shi (JP); DENSO CORPORATION, Kariya-city (JP); AISIN CORPORATION, Kariya (JP)

(72) Inventor: Takuhiro OMI, Anjo-shi (JP)

(73) Assignees: TOYOTA JIDOSHA KABUSHIKI KAISHA, Toyota-shi (JP); DENSO CORPORATION, Kariya-city (JP); AISIN CORPORATION, Kariya (JP)

(21) Appl. No.: 18/771,146

(22) Filed: Jul. 12, 2024

(30) Foreign Application Priority Data
Jul. 14, 2023 (JP) 2023-116039

(51) Int. Cl. G06V 20/59; B60Q 9/00; G06V 20/52; G06V 40/16; G06V 40/20

(52) U.S. Cl. CPC G06V 20/597; B60Q 9/00; G06V 20/52; G06V 40/28; G06V 40/161

(57) ABSTRACT

A driver monitoring device includes an acquisition part which acquires a driver monitor camera image including a face of a driver of a vehicle captured by a driver monitor camera and estimation part which estimates whether the driver is holding a mobile phone located outside shooting range of the driver monitor camera in a hand of the driver and calling based on the driver monitor camera image acquired by the acquisition part.

### FIELD

The present disclosure relates to driver monitoring device, driver monitoring method, and non-transitory recording medium.

### BACKGROUND

PTL 1 (Japanese Unexamined Patent Publication No. 2021-527900) describes that a camera located directly in front of a seat of a driver captures an image of the driver, head posture information, eye state information, mouth state information, etc., are obtained from the image of the driver, distracted state of the driver is detected based on them, and it is determined whether distracted behavior (telephone call operation, etc.) occurs (local area of a face (mouth area, eye area, etc.), hand area, and operation target frame including an operation-related object (mobile phone, etc.) are determined).

In the art described in PTL 1, it is impossible to determine whether the driver is holding the mobile phone (which is not included in the image of the driver) located outside shooting range of the camera in the hand of the driver and calling. Accordingly, it is impossible to inhibit the driver holding the mobile phone located outside the shooting range of the camera in the hand of the driver and calling.

### SUMMARY

In view of the above-mentioned score, the present disclosure has as its object the provision of driver monitoring device, driver monitoring method, and non-transitory recording medium which can inhibit a driver holding a mobile phone located outside shooting range of a driver monitor camera in a hand of the driver and calling.
(1) One aspect of the present disclosure is a driver monitoring device including a processor configured to: acquire a driver monitor camera image including a face a driver of a vehicle captured by a driver monitor camera; and estimate whether the driver is holding a mobile phone located outside shooting range of the driver monitor camera in a hand of the driver and calling based on the driver monitor camera image, wherein the processor is configured to estimate that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.
(2) In the driver monitoring device of the aspect (1), the characteristic act of the driver which shows the continuation of the call may include at least one of movement of a mouth of the driver which shows the continuation of the call, act of moving the hand of the driver holding the mobile phone to a position other than a position where the hand of the driver grips a steering wheel and act of the driver glancing at the mobile phone which is held by the hand of the driver, the processor may be configured to estimate whether the act of moving the hand of the driver holding the mobile phone to the position other than the position where the hand of the driver grips the steering wheel is detected by using the driver monitor camera image and skeleton detection.
(3) In the driver monitoring device of the aspect (1) or (2), the processor may be configured to alert in different ways between when the state in which the mobile phone and the hand of the driver holding the mobile phone are included in the driver monitor camera image is detected and when the state in which the mobile phone and the hand of the driver holding the mobile phone are no longer included in the driver monitor camera image and the characteristic act of the driver which shows the continuation of the call are detected.
(4) Another aspect of the present disclosure is a driver monitoring method including: acquiring a driver monitor camera image including a face a driver of a vehicle captured by a driver monitor camera; and estimating whether the driver is holding a mobile phone located outside shooting range of the driver monitor camera in a hand of the driver and calling based on the driver monitor camera image, wherein it is estimated that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.
(5) Another aspect of the present disclosure is a non-transitory recording medium having recorded thereon a computer program for causing a processor to execute a process including: acquiring a driver monitor camera image including a face a driver of a vehicle captured by a driver monitor camera; and estimating whether the driver is holding a mobile phone located outside shooting range of the driver monitor camera in a hand of the driver and calling based on the driver monitor camera image, wherein it is estimated that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.

According to the present disclosure, it is possible to inhibit a driver holding a mobile phone located outside shooting range of a driver monitor camera in a hand of the driver and calling.

### BRIEF DESCRIPTION OF DRAWINGS

FIG. 1 is a view showing an example of a vehicle 1 to which a driver monitoring device 20 of a first embodiment is applied.

FIG. 2 is a view showing an example of a specific configuration of the driver monitoring device 20 shown in FIG. 1.

FIG. 3 is a view showing an example of arrangement of the driver monitor camera 3 shown in FIG. 1.

FIG. 4A shows a state in which a driver of the vehicle 1 is gripping a steering wheel ST with both hands before holding the mobile phone in a hand of the driver of the vehicle 1 (before holding the mobile phone in the hand and starting a call).

FIG. 4B shows a state in which the driver of the vehicle 1 is holding the mobile phone to an ear of the driver and calling while the driver is driving.

FIG. 4C shows a state in which the driver of the vehicle 1 moves the hand of the driver holding the mobile phone to a position other than a position where the hand grips the steering wheel ST and is continuing the call.

FIG. 5 is a flowchart for explaining an example of processing performed by the driver monitoring device 20 of the first embodiment.

### DESCRIPTION OF EMBODIMENTS

Below, referring to the drawings, embodiments of driver monitoring device, driver monitoring method, and non-transitory recording medium of the present disclosure will be explained.

### First Embodiment

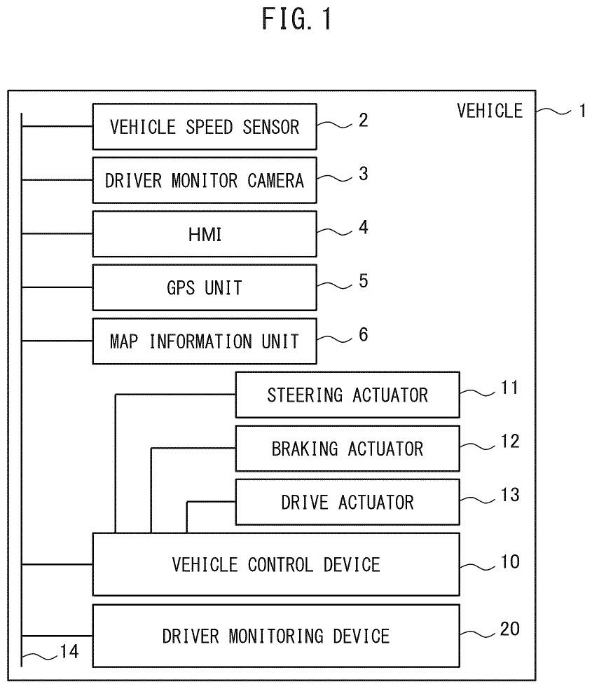

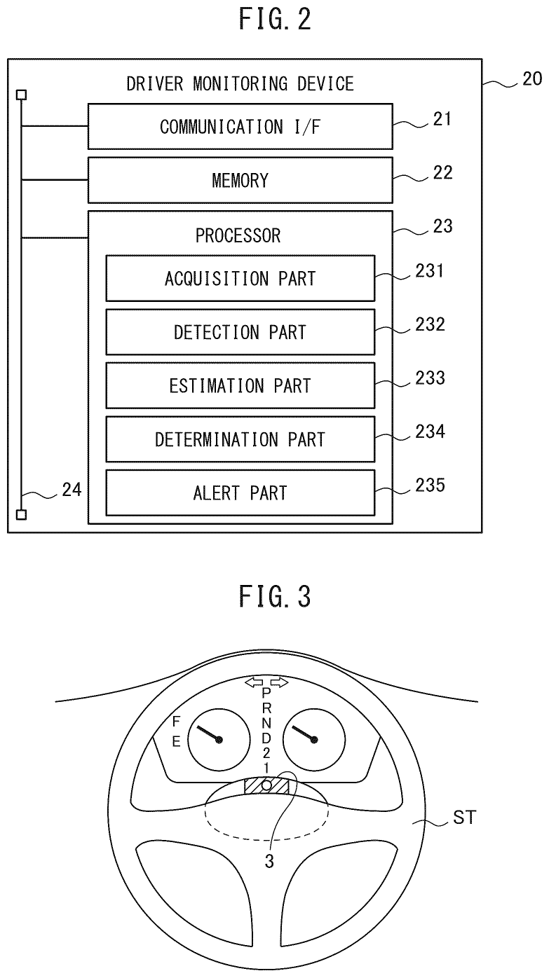

FIG. 1 is a view showing an example of a vehicle 1 to which a driver monitoring device 20 of a first embodiment is applied. FIG. 2 is a view showing an example of a specific configuration of the driver monitoring device 20 shown in FIG. 1. FIG. 3 is a view showing an example of arrangement of the driver monitor camera 3 shown in FIG. 1.

In the example shown in FIG. 1 to FIG. 3, the vehicle 1 includes vehicle speed sensor 2, driver monitor camera 3, HMI (Human Machine Interface) 4, GPS (Global Positioning System) unit 5, map information unit 6, vehicle control device 10, steering actuator 11, braking actuator 12, drive actuator 13, in-vehicle network 14, and the driver monitoring device 20. As shown in FIG. 3, the driver monitor camera 3 is disposed on top of a steering column (not shown) of the vehicle 1 so as to be able to image a face and a part of an upper body of a driver of the vehicle 1.

In another example, the driver monitor camera 3 may be disposed in a center cluster of the vehicle 1, or the driver monitor camera 3 may be disposed in room mirror, meter panel, meter hood, or the like of the vehicle 1.

In the example shown in FIG. 1 to FIG. 3, the driver monitoring device 20 includes communication interface (I/F) 21, memory 22, processor 23 and signal line 24. The processor 23 has the function as an acquisition part 231, the function as a detection part 232, the function as an estimation part 233, the function as a determination part 234 and the function as an alert part 235.

The acquisition part 231 acquires a driver monitor camera image including the face of the driver of the vehicle 1 captured by the driver monitor camera 3.

The detection part 232 has the function of detecting the position of the face of the driver of the vehicle 1 included in the driver monitor camera image by using a known face recognition technique such as a face recognition AI (artificial intelligence). The detection part 232 has the function of detecting a hand of the driver of the vehicle 1 included in the driver monitor camera image by using the same technique as a known face component detection technique.

Furthermore, the detection part 232 has the function of detecting an object (for example, a mobile phone or the like) included in the driver monitor camera image by using a known object detection technique.

In other words, the detection part 232 has the function to detect a state in which the mobile phone and the hand of the driver of the vehicle 1 holding the mobile phone are included in the driver monitor camera image (i.e., a state in which the hand of the driver of the vehicle 1 holding the mobile phone is near the face of the driver of the vehicle 1). In addition, the detection part 232 has the function of detecting a state in which the mobile phone and the hand of the driver of the vehicle 1 holding the mobile phone are no longer included in the driver monitor camera image (i.e., a state in which the mobile phone or the hand of the driver of the vehicle 1 is no longer near the face of the driver of the vehicle 1).

For example, the National Standard of the People's Republic of China GB/T 41797-2022 requires drivers to be alerted when a hand-held smartphone is held from the face to 5 cm for three seconds or more. However, even if it is alerted to the driver, it is not expected that the driver will stop the call immediately, and it is conceivable that the call is continued by using a speakerphone. For example, in order to perform detection in compliance with the National Standard of the People's Republic of China GB/T 41797-2022, the face of the driver, the hand near the face, the smartphone body, etc. will be detected by the driver monitoring, but if the smartphone is held near the horn pad, etc. by using the speakerphone, the hand of the driver and the smartphone will deviate from the angle of view of the driver monitor camera (the hand of the driver and the smartphone will be located outside the shooting range of the driver monitor camera). Accordingly, it becomes difficult to detect the hand of the driver and the smartphone. It is necessary to detect this condition because the continuation of the call by the smartphone by abuse of the weak point of the driver monitoring will further promote the unsafe action.

In view of the above-described points, in the example shown in FIG. 1 to FIG. 3, the detection part 232 has the function of detecting a characteristic act of the driver of the vehicle 1 which shows the continuation of the call using the mobile phone moved outside the shooting range of the driver monitor camera 3 (the “characteristic act of the driver of the vehicle 1 which shows the continuation of the call” will be described in detail later).

Specifically, the detection part 232 detects the characteristic act of the driver of the vehicle 1 showing the continuation of the call using the mobile phone moved outside the shooting range of the driver monitor camera 3 based on, for example, the driver camera monitor image acquired by the acquisition part 231 and the result of skeleton detection (for example, the direction of upper arm, forearm, etc. of the driver which are located outside of the shooting range of the driver monitor camera 3), for example, by using a model. The model is obtained by learning using a teacher data which is a data set including the driver monitor camera image, the result of the skeleton detection and a label which shows whether the characteristic act indicating the continuation of the call using the mobile phone which is moved outside the shooting range of the driver monitor camera is taken by the driver who is the subject of the skeleton detection and included in the driver monitor camera image. (As the skeleton detection, technique described in the WEB site shown by the following URL.) (The result of the skeleton detection is, for example, the direction of upper arm, forearm, etc. of the driver which are located outside of the shooting range of the driver monitor camera.) https://www.autoconnectedcar.com/2019/03/eyesight-tech-knows-whos-in-the-car/

In the technique described in the WEB site shown by the URL above, the direction of the upper arm (only a part is included in the image) of the driver in the image of the top page of that WEB site can be detected. In addition, this skeleton detection can detect the direction of the forearm (up to the elbow is included in the image) of the passenger in the image.

In another example, the detection part 232 may detect the characteristic act of the driver of the vehicle 1 showing the continuation of the call using the mobile phone moved outside the shooting range of the driver monitor camera 3 based on the driver monitor camera image acquired by the acquisition part 231 and the result of the skeleton detection (for example, the position, angle, or the like of the upper arm, forearm, or the like of the driver of the vehicle 1 located outside the shooting range of the driver monitor camera) without using the previously-trained model.

In the example shown in FIG. 1 to FIG. 3, the characteristic act of the driver of the vehicle 1 showing the continuation of the call using the mobile phone moved outside the shooting range of the driver monitor camera 3 includes the movement of the mouth of the driver of the vehicle 1 that showing the continuation of the call.

In other words, the detection part 232 has the function of detecting the movement of the mouth of the driver of the vehicle 1 showing the continuation of the call using the mobile phone moved outside the shooting range of the driver monitor camera 3. Specifically, the detection part 232 detects the movement of the mouth of the driver of the vehicle 1 showing the continuation of the call using the mobile phone moved outside the shooting range of the driver monitor camera 3 based on the driver monitor camera image acquired by the acquisition part 231, for example, by using a model obtained by performing learning using the teacher data which is a data set including the driver monitor camera image and a label which shows whether the driver included in the driver monitor camera image made the movement of the mouth indicating the continuation of the call using the mobile phone moved outside the shooting range of the driver monitor camera image.

In addition, in the example shown in FIG. 1 to FIG. 3, the characteristic act of the driver of the vehicle 1 showing the continuation of the call using the mobile phone moved outside the shooting range of the driver monitor camera 3 includes an act of moving the hand of the driver of the vehicle 1 holding the mobile phone to a position (which is a position outside the shooting range of the driver monitor camera 3) other than a position where the hand of the driver of the vehicle 1 grips a steering wheel ST.

That is, the detection part 232 has the function of detecting the act of the driver of the vehicle 1 that moves the hand of the driver of the vehicle 1 holding the mobile phone to the position other than the position where the hand of the driver of the vehicle 1 grips the steering wheel ST, the act indicates the continuation of the call using the mobile phone moved outside the shooting range of the driver monitor camera 3. Specifically, the detecting part 232 detects the action of the driver of the vehicle 1 that moves the hand of the driver of the vehicle 1 holding the mobile phone to the position other than the position where the hand of the driver of the vehicle 1 grips the steering wheel ST by using the skeleton detection described above.

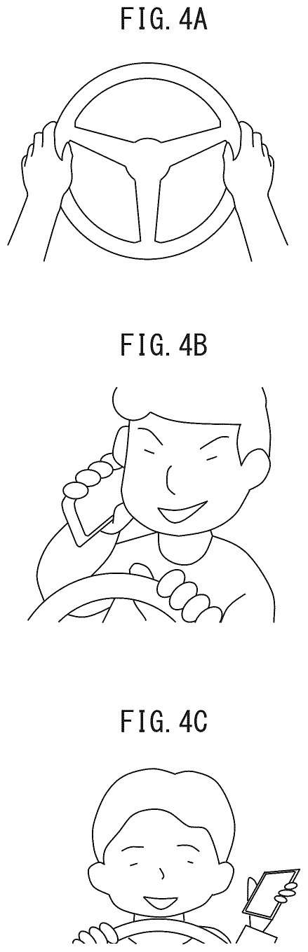

FIG. 4A to FIG. 4C are diagrams for conceptually explaining how to use the skeleton detection in the driver monitoring device 20 of the first embodiment. Specifically, FIG. 4A shows a state in which the driver of the vehicle 1 is gripping the steering wheel ST with both hands before holding the mobile phone in the hand of the driver of the vehicle 1 (before holding the mobile phone in the hand and starting the call). FIG. 4B shows a state in which the driver of the vehicle 1 is holding the mobile phone to an car of the driver and calling while the driver is driving. FIG. 4C shows a state in which the driver of the vehicle 1 moves the hand of the driver holding the mobile phone to the position other than the position where the hand grips the steering wheel ST and is continuing the call.

In an example of the driver monitoring device 20 of the first embodiment, the driver monitor camera image in a state in which the driver of the vehicle 1 grips the steering wheel ST with both hands before holding the mobile phone to the hand (before holding the mobile phone to the hand and starting the call) as shown in FIG. 4A is previously stored in the memory 22.

Further, in the example of the driver monitoring device 20 of the first embodiment, when a state (a state shown in FIG. 4B) in which the driver of the vehicle 1 is holding the mobile phone in the hand to the car and calling while driving transitions to a state (a state shown in FIG. 4C) in which the driver of the vehicle 1 is moving the hand holding the mobile phone to the position other than the position where the hand grips the steering wheel ST and continues the call, the mobile phone held in the hand of the vehicle 1 is located outside the shooting range of the driver monitor camera 3. The detection part 232 detects, for example, the direction of the upper arm and the forearm of the driver of the vehicle 1 by using the skeleton detection (that is, detects that the position and the angle of the upper arm and the forearm of the driver of the vehicle 1 have changed), and detects that the driver of the vehicle 1 has moved the hand of the driver of the vehicle 1 holding the mobile phone to the position other than the position where the hand grips the steering wheel ST (the characteristic act of the driver of the vehicle 1).

In the example shown in FIG. 1 to FIG. 3, the estimation part 233 compares, for example, the result of the skeleton detection in the state shown in FIG. 4A with the result of the skeleton detection in the state shown in FIG. 4C, thereby estimating whether the driver of the vehicle 1 is holding the mobile phone located outside the shooting range of the driver monitor camera 3 in the hand of the driver and calling (continuing a call) based on the driver monitor camera image acquired by the acquisition part 231.

In addition, in the example shown in FIG. 1 to FIG. 3, the estimation part 233 not only uses the technique of the skeleton detection but also uses the model obtained by learning using the teacher data which is the data set including the driver camera monitor image in the state shown in FIG. 4A, the driver camera monitor image in the state shown in the FIG. 4C and the label which shows whether the driver is holding the mobile phone located outside the shooting range of the driver monitor camera and continues the call when the state shown in FIG. 4A transitions to the state shown in FIG. 4C, and thereby estimates whether the driver of the vehicle 1 is holding the mobile phone located outside the shooting range of the driver monitor camera 3 and calling (continuing the call) based on the driver monitor camera image acquired by the acquisition part 231.

In another example, the estimation part 233 may compare the result of the skeleton detection in the state shown in FIG. 4A with the result of the skeleton detection in the state shown in FIG. 4C, and thereby estimate whether the driver of the vehicle 1 is holding the mobile phone located outside the shooting range of the driver monitor camera 3 and calling (continuing the call) without using the learned model described above.

Furthermore, in the example shown in FIG. 1 to FIG. 3, the characteristic act of the driver of the vehicle 1 which shows the continuation of the call using the mobile phone moved outside the shooting range of the driver monitor camera 3 includes an act of the driver of the vehicle 1 glancing at the mobile phone held by the hand of the driver.

In other words, the detection part 232 has the function of detecting the act of the driver of the vehicle 1 glancing at the mobile phone held by the hand of the driver, which indicates the continuation of the call using the mobile phone moved outside the shooting range of the driver monitor camera 3. Specifically, the detection part 232 detects the act of the driver of the vehicle 1 glancing at the mobile phone held by the hand of the driver based on the driver monitor camera image acquired by the acquisition part 231, for example, by using the model obtained by learning using the teacher data which is the data set including the driver monitor camera image and the label which shows whether gaze and/or face orientation of the driver included in the driver monitor camera image alternates between the front of the vehicle and a specific position other than the front of the vehicle in a short period.

Further, in the example shown in FIG. 1 to FIG. 3, the estimation part 233 has the function of estimating whether the driver of the vehicle 1 is in a call state. In detail, the estimation part 233 has the function of estimating whether the driver of vehicle 1 is calling in a state in which the hand of the driver of the vehicle holding the mobile phone is near the face of the driver of the vehicle 1.

Specifically, when the detection part 232 detects the state in which the mobile phone and the hand of the driver of the vehicle 1 holding the mobile phone are included in the driver monitor camera image (i.e., the state in which the hand of the driver of the vehicle 1 holding the mobile phone is near the face of the driver of the vehicle 1), the estimation part 233 estimates that the driver of the vehicle 1 is calling in the state in which the hand of the driver of the vehicle 1 holding the mobile phone is near the face of the driver of the vehicle 1.

For example, when the detection part 232 detects the state in which the hand of the driver of the vehicle 1 is not included in the driver monitor camera image (for example, the state in which the hand of the driver of the vehicle 1 holding the mobile phone is not near the face of the driver of the vehicle 1) and when a predetermined time does not elapse after the alert part 235 issues a first alert to be described later, the estimation part 233 estimates that there is a possibility that the driver of the vehicle 1 is holding the mobile phone located outside the shooting range of the driver monitor camera 3 in the hand of the driver and calling (there is a possibility that the call is being continued).

For example, when the detection part 232 detects the state in which the hand of the driver of the vehicle 1 is not included in the driver monitor camera image when the counter t is zero and the counter n is zero which is described later, estimation part 233 estimates that the driver of the vehicle 1 is not calling with the mobile phone.

Furthermore, the estimation part 233 has the function of estimating whether the driver of the vehicle 1 is holding the mobile phone located outside the shooting range of the driver monitor camera 3 in the hand and calling.

Specifically, the estimation part 233 estimates that the driver of the vehicle 1 is holding the mobile phone located outside the shooting range of the driver monitor camera 3 in the hand and calling (continuing the call) when the detection part 232 detects the state in which the mobile phone and the hand of the driver of the vehicle 1 holding the mobile phone are included in the driver monitor camera image and then the detection part 232 detects the state in which the mobile phone and the hand of the driver of the vehicle 1 holding the mobile phone are no longer included in the driver monitor camera image and the detection part 232 detects the characteristic act of the driver of the vehicle 1 which shows the continuation of the call (in detail, the detection part 232 detects all of the movement of the mouth of the driver of the vehicle 1 which shows the continuation of the call, the act of the driver of the vehicle 1 in which the hand of the driver holding the mobile phone is moved to the position other than the position where the hand of the driver grips the steering wheel ST and act of the driver of the vehicle 1 glancing at the mobile phone which is held by the hand of the driver).

Further, the estimation part 233 has the function of estimating whether the act of the driver of the vehicle 1 in which the hand of the driver holding the mobile phone is moved to the position other than the position where the hand of the driver grips the steering wheel ST is detected by the detection part 232 by using the driver monitor camera image and the skeleton detection. When the detection part 232 detects the act of the driver of the vehicle 1 in which the hand of the driver holding the mobile phone is moved to the position other than the position where the hand of the driver grips the steering wheel ST, the estimation part 233 estimates (determines) that the hand of the driver holding the mobile phone is moved to the position other than the position where the hand of the driver grips the steering wheel ST.

Furthermore, in the example shown in FIG. 1 to FIG. 3, the determination part 234 executes various determinations. The alert part 235 has the function of issuing the first alert and the function of issuing a second alert, the mode of the second alert is different from the mode of the first alert (e.g., the level of the second alert is stronger than the level of the first alert). That is, the alert part 235 alerts in different ways between when the state in which the mobile phone and the hand of the driver of the vehicle 1 holding the mobile phone are included in the driver monitor camera image is detected by the detection part 232 and when the state in which the mobile phone and the hand of the driver of the vehicle 1 holding the mobile phone are no longer included in the driver monitor camera image and the characteristic act of the driver of the vehicle 1 which shows the continuation of the call are detected by the detection part 232.

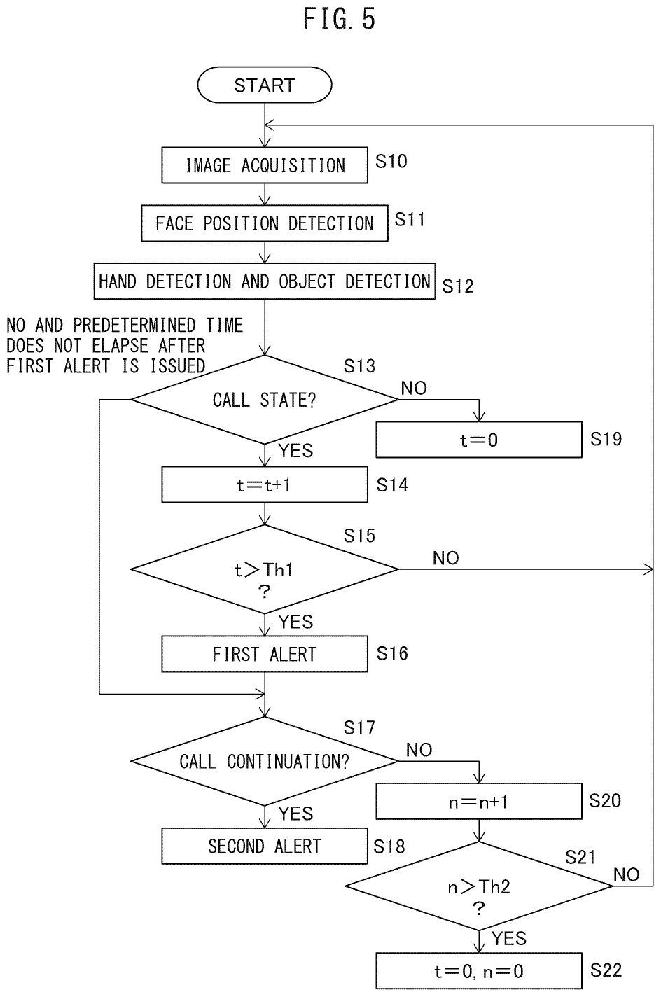

FIG. 5 is a flowchart for explaining an example of processing performed by the driver monitoring device 20 of the first embodiment. The processing shown in FIG. 5 is performed, for example, when the vehicle speed sensor 2 detects a traveling state of the vehicle 1 (for example, the vehicle speed of 10 km/h or more).

In the example shown in FIG. 5, at step S10, the acquisition part 231 acquires the driver monitor camera image.

At step S11, the detection part 232 detects the position of the face of the driver of the vehicle 1.

At step S12, the detection part 232 detects the hand of the driver of the vehicle 1 and the object (mobile phone).

At step S13, the estimation part 233 estimates whether the driver of the vehicle 1 is in the call state. When the driver of the vehicle 1 is in the call state (the state in which the hand of the driver of the vehicle 1 holding the mobile phone is near the face of the driver of the vehicle 1), the routine proceeds to step S14. When the driver of the vehicle 1 is not holding the mobile phone in the hand and calling (for example, when the hand of the driver of the vehicle 1 is not included in the driver monitor camera image when the counter n is zero), the routine proceeds to step S19. When the hand of the driver of the vehicle 1 is not included in the driver monitor camera image and when the predetermined time does not elapse after the alert part 235 issues the first alert, the routine proceeds to step S17.

At step S14, for example, the alert part 235 performs the increment of the counter t.

At step S15, the determination part 234 determines whether the counter t is greater than the threshold Th1. When the counter t is greater than the threshold Th1, the routine proceeds to step S16. When the counter t is equal to the threshold Th1 or less, the routine returns to step S10.

At step S16, the alert part 235 determines that the driver of the vehicle 1 is in the call state (the state in which the hand of the driver of the vehicle 1 holding the mobile phone is near the face of the driver of the vehicle 1) and issues the first alert of, for example, several seconds length (the alert part 235 makes the HMI 4 output the first alert). Then the routine proceeds to step S17.

At step S17, the estimation part 233 estimates whether the driver of the vehicle 1 is holding the mobile phone located outside the shooting range of the driver monitor camera 3 in the hand and calling (continuing the call). When the estimation part 233 estimates that the driver of the vehicle 1 is holding the mobile phone located outside the shooting range of the driver monitor camera 3 in the hand and continuing the call, the routine proceeds to step S18. When the estimation part 233 does not estimate that the driver of the vehicle 1 is holding the mobile phone located outside the shooting area of the driver monitor camera 3 in the hand and continuing the call, the routine proceeds to step S20.

At step S18, the alert part 235 issues the second alert, the level of the second alert is stronger than the level of the first alert (the alert part 235 makes the HMI 4 output the first alert).

At step S19, for example, the alert part 235 resets the counter t.

At step S20, for example, the alert part 235 performs the increment of the counter n.

At step S21 step, the determination part 234 determines whether the counter n is greater than the threshold Th2. When the counter n is greater than the threshold Th2, the routine proceeds to step S22. When the counter n is threshold Th2 or less, the routine returns to step S10.

At step S22, for example, the alert part 235 resets the counter t and the counter n.

As described above, in the driver monitoring device 20 of the first embodiment, the issuance of the second alert prevents the driver of the vehicle 1 from pretending to have stopped calling and continuing the call without abandoning the call according to the first alarm after the first alert is issued for the driver of the vehicle 1 holding the mobile phone in the hand and calling.

### Second Embodiment

The vehicle 1 to which the driver monitoring device 20 of a second embodiment is applied is configured similarly to the vehicle 1 to which the driver monitoring device 20 of the first embodiment described above is applied except for the point to be described later. As described above, in the driver monitoring device 20 of the first embodiment, it is estimated that the driver of the vehicle 1 is holding the mobile phone located outside the shooting range of the driver monitor camera 3 in the hand and calling (continuing the call) when the detection part 232 detects all of the movement of the mouth of the driver of the vehicle 1 which shows the continuation of the call, the act of the driver of the vehicle 1 moving the hand of the driver of the vehicle 1 holding the mobile phone to the position other than the position where the hand of the driver grips the steering wheel ST and the act of the driver of the vehicle 1 glancing at the mobile phone which is held by the hand of the driver, as the characteristic act of the driver of the vehicle 1 which shows the continuation of the call. On the other hand, in the driver monitoring device 20 of the second embodiment, it is estimated that the driver of the vehicle 1 is holding the mobile phone located outside the shooting range of the driver monitor camera 3 in the hand and calling (continuing the call) when the detection part 232 detects any one of two of the movement of the mouth of the driver of the vehicle 1 which shows the continuation of the call, the act of the driver of the vehicle 1 moving the hand of the driver of the vehicle 1 holding the mobile phone to the position other than the position where the hand of the driver grips the steering wheel ST and the act of the driver of the vehicle 1 glancing at the mobile phone which is held by the hand of the driver, as the characteristic act of the driver of the vehicle 1 which shows the continuation of the call.

As described above, although the embodiments of the driver monitoring device, the driver monitoring method, and the non-transitory recording medium of the present disclosure have been described with reference to the drawings, the driver monitoring device, the driver monitoring method, and the non-transitory recording medium of the present disclosure are not limited to the above-described embodiments, and appropriate changes can be made without departing from the scope of the present disclosure. The configuration of each example of the embodiment described above may be appropriately combined.

1. A driver monitoring device comprising a processor configured to:
acquire a driver monitor camera image including a face of a driver of a vehicle captured by a driver monitor camera; and
estimate whether the driver is holding a mobile phone located outside shooting range of the driver monitor camera in a hand of the driver and calling based on the driver monitor camera image,
wherein the processor is configured to estimate that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.

2. The driver monitoring device according to claim 1, wherein
the characteristic act of the driver which shows the continuation of the call includes at least one of movement of a mouth of the driver which shows the continuation of the call, act of moving the hand of the driver holding the mobile phone to a position other than a position where the hand of the driver grips a steering wheel and act of the driver glancing at the mobile phone which is held by the hand of the driver,
the processor is configured to estimate whether the act of moving the hand of the driver holding the mobile phone to the position other than the position where the hand of the driver grips the steering wheel is detected by using the driver monitor camera image and skeleton detection.

3. The driver monitoring device according to claim 1, wherein
the processor is configured to alert in different ways between when the state in which the mobile phone and the hand of the driver holding the mobile phone are included in the driver monitor camera image is detected and when the state in which the mobile phone and the hand of the driver holding the mobile phone are no longer included in the driver monitor camera image and the characteristic act of the driver which shows the continuation of the call are detected.

4. A driver monitoring method comprising:
acquiring a driver monitor camera image including a face of a driver of a vehicle captured by a driver monitor camera; and
estimating whether the driver is holding a mobile phone located outside shooting range of the driver monitor camera in a hand of the driver and calling based on the driver monitor camera image,
wherein it is estimated that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.

5. A non-transitory recording medium having recorded thereon a computer program for causing a processor to execute a process comprising:
acquiring a driver monitor camera image including a face of a driver of a vehicle captured by a driver monitor camera; and
estimating whether the driver is holding a mobile phone located outside shooting range of the driver monitor camera in a hand of the driver and calling based on the driver monitor camera image,
wherein it is estimated that the driver is holding the mobile phone located outside the shooting range of the driver monitor camera in the hand of the driver and calling when a state in which the mobile phone and the hand of the driver holding the mobile phone are included in the driver monitor camera image is detected and then a state in which the mobile phone and the hand of the driver holding the mobile phone are no longer included in the driver monitor camera image is detected and a characteristic act of the driver which shows continuation of a call is detected.
